(19) United States
(12) Patent Application Publication
(10) Pub. No.: US 2007/0231516 A1
(43) Pub. Date: Oct. 4, 2007

(54) Laminate material for vacuum-packed packages

(76) Inventors: Robert Thor Versluys, Florence, SC (US); Douglas Frost, Charlotte, NC (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/397,070

(22) Filed: Apr. 4, 2006

(51) Int. Cl. B32B 27/32

(52) U.S. Cl. 428/35.2

(57) ABSTRACT

A package is disclosed which is constructed from at least one flexible laminate panel having first and second plies. The panel has a strong bond between the first and second plies around a perimeter portion of the panel and relatively weaker bond between the first and second plies in a central portion of the panel. A portion of the first ply separates from the second ply upon the introduction of a vacuum to an interior cavity formed by the package. The relatively inner ply conforms to the package contents while the outside panel remains smooth.

### FIELD OF THE INVENTION

The invention relates to the field of laminate packaging, in particular, a laminate used to package foodstuffs.

### BACKGROUND

Foods such as ground coffee are often vacuum-packed in the shape of bricks. This method of packaging involves applying a vacuum to the inside of a package to remove gases within the package. The vacuum force is typically strong enough to cause the packaging material, which is generally a laminate, to become embossed by the grainy surface of the compressed food. While this texture may be generally accepted in the marketplace as the standard for vacuum packed foods, it does not have a particularly desirable appearance.

### SUMMARY OF THE INVENTION

This invention relates to packaging materials for food, specifically laminate materials. A first aspect of the invention is a package defining a central cavity. The package is constructed from at least one flexible laminate panel having first and second plies. The panel has a strong bond between the first and second plies around a perimeter portion of the panel and a relatively weaker bond between the plies in a central portion. The bond within the central portion permits the first ply to separate from the second ply upon the introduction of vacuum to an interior cavity of the package.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a perspective view of laminate material constructed according to an embodiment of the present invention.

FIG. 2 is a side elevational view of a piece of the laminate material shown in FIG. 1.

FIG. 3 is a cross-sectional view of the laminate material of FIG. 1.

FIG. 4 is a cross-sectional view of a second embodiment of a laminate material.

FIG. 5 is a cross-sectional view of a third embodiment of a laminate material.

FIG. 6 is a side elevational view of a piece of laminate material according to an embodiment of the present invention, showing fold lines.

FIG. 7 is a cross sectional view of a container constructed with laminate material according to an embodiment of the present invention.

FIG. 8 is a perspective view of a container constructed with laminate material according to an embodiment of the present invention.

### DETAILED DESCRIPTION OF THE DRAWINGS

It will be appreciated that the following description is intended to refer to specific embodiments of the invention selected for illustration in the drawings and is not intended to define or limit the invention, other than in the appended claim.

In the figures, in which like reference numerals indicate like elements, there is shown embodiments of a laminate material which is generally referred to by the numeral 10. The laminate material 10 is preferably used for the vacuum packaging of foods, such as coffee. One embodiment of such package retains food stuff which is formed into the shape of a brick. The laminate material 10 may be formed on standard flexible packaging converting equipment.

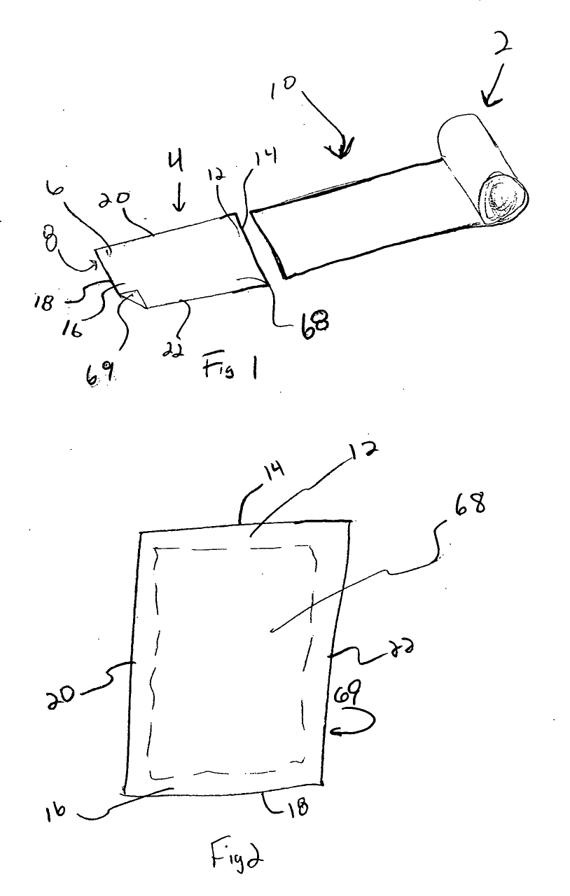

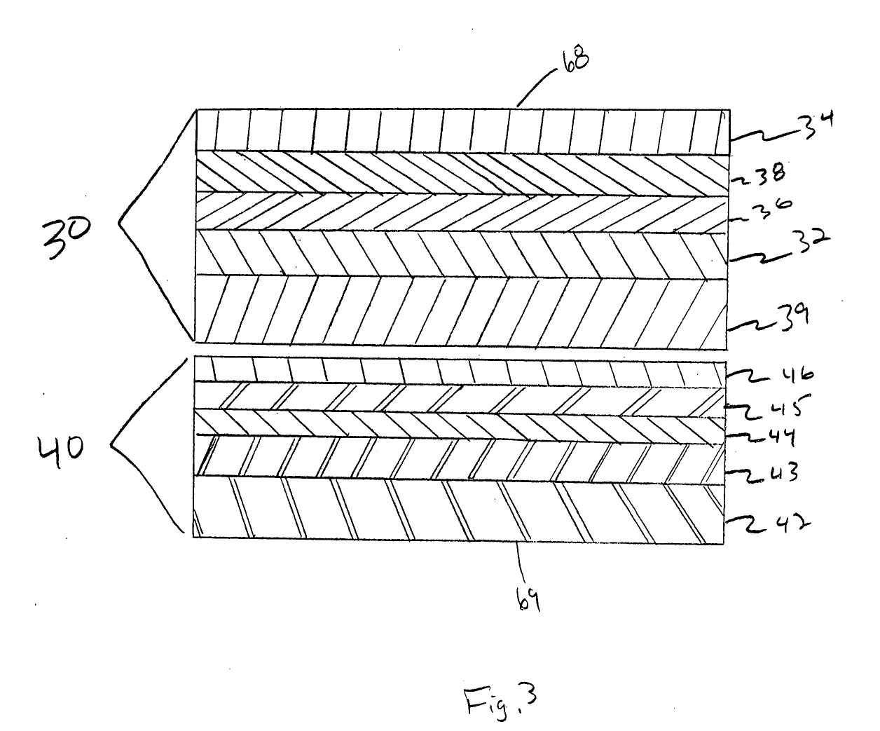

As shown in FIG. 1, the laminate material 10 is preferably retained in a roll 2. Each roll 2 preferably comprises enough material for many packages. The laminate 10 is unrolled longitudinally and cut laterally into pieces 4 which form individual packages. As shown in FIG. 2, each piece of laminate material 10 has a first lateral end portion 12, with a top end 14, and a second lateral end portion 16, with a bottom end 18. First and second longitudinal side portions 20, 22 extend on the outer edges, between the top end 14 and the bottom end 18. The top and bottom ends 14, 18 and the longitudinal sides 20, 22 define the outer edges. First and second faces 68, 69 define outer and inner surfaces of the package constructed from the laminate material 10. It is preferable that the laminate material 10 be constructed from an outer ply 30 and an inner ply 40. The first ply 30 is preferably extrusion laminated to the second ply 40, as will be described in further detail below.

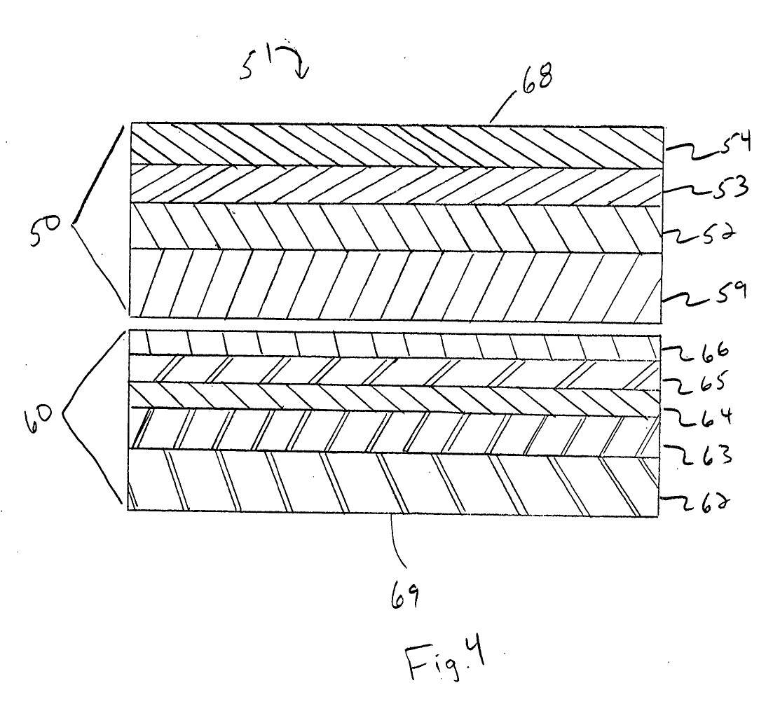

With reference to FIG. 3, the first ply 30 preferably comprises a paper layer 32, with a weight of about 20 lbs./ream, and a 48 gauge polyester (PE) web layer 34. Preferably, the PE print web layer 34 makes up the outer surface 68 of the package when the material is used to package food. The paper layer 32 may be coated on one side to enhance printability. Such a coating may consist of a clay material. The coated side will generally face the PE print web material. The paper layer 32 is adhered to the web layer 34 using a laminating adhesive 36, which is preferably applied at a rate of about 1-2 lbs/ream. The web 34 is reverse printed with an ink layer 38 prior to being laminated to the paper layer 32. Alternatively, the printing may be applied to the paper 32, or some combination of both. The printing, in combination with the paper layer 32, makes up the design of the outer surface of the packaging.

A release primer 39 is selectively applied in a pattern to the side of the paper layer 32 that is not covered in ink 36 and the PE web layer 34. The release primer 39 is applied to facilitate selective delamination of the inner ply 40 from the outer ply 30. The release primer 39 is preferably permeable to gasses and may comprise a catalytically cured silicone release coating, a polyamide over print varnish (OPV) heavily loaded with wax and anti-block additives, or an alternate material that would prevent the formulation of a destruct-type bond between the paper of the first ply 30 and the second ply 40. In other words, the release layer 39 preferably will fail before any of the other layers.

The first ply 30 is constructed by unrolling the PE web 34 and reverse printing the ink 38 onto the PE web 34. The reverse printed web 34 then passes through a laminating station where a laminating adhesive 36 is applied to the PE web 34. The paper layer 32 is unwound from a roll and the paper layer 32 and the PE web 34 are both passed through a laminator nip roller assembly and compressed together. After the paper layer 32 is laminated onto the PE web 34, the release primer 39 is selectively applied to the other side of the paper layer 32. The release layer 39 is applied to the center 24 of each piece 45 of laminate material. Alternatively, the release layer 39 may be applied across the entire piece, with the exception of the longitudinal side portions 20, 22.

The second ply 40 is made up of a sealant film layer 42 and a barrier layer 44. Preferably, the sealant film 42 is a polyolefin blend or some other sealant layer that may be sealed according to known methods, such as heat sealing. The barrier layer 44 is preferably about 35 gauge and constructed from a metallic foil or some other suitable film. The sealant layer 42 is adhered to the barrier layer 44 using a laminating adhesive 43, which is typically applied at a rate of about 1-2 lbs/ream. A PE extrudate layer 46 is extruded at the rate of approximately 7-10 lbs/ream onto the barrier layer 44. An acid copolymer tie layer 45, having a weight of approximately 2-3 lbs/ream, is disposed between the barrier layer 44 and the PE extrudate layer 46 to facilitate adhesion between the two layers. The tie layer 45 facilitates the bonding of the PE extrudate 46 to the barrier layer 44. The tie layer 45 may be applied to the barrier layer 44 prior to extruding the PE onto the barrier layer 44. Alternatively, the tie layer 45 may be extruded onto the barrier layer 44, either simultaneously with the PE extrusion 46 or prior to the extrusion of the PE onto the barrier layer 44.

The second ply 40 is constructed by first unrolling a the sealant layer 42, applying laminating adhesive 43 thereto and laminating the barrier layer 44 to the sealant layer 42 by passing the layers 42, 43, 44 (barrier and sealant) through a laminator nip roller assembly to compress the layers 42, 43, 44 together. After passing through the nip roller, the tie layer 45 and the PE extrudate 46 are extruded onto the second ply 40.

Preferably, immediately after the extrusion of the PE extrudate 46 onto the barrier material 44, the first ply 30, which has been previously laminated together, is laminated onto the molten PE extrudate layer 46, with the release primer 39 and the paper layer 32 engaging the PE extrudate layer 46. The paper layer 32 of the first ply 30, which is at least partially coated with release primer 39 that has been selectively applied, faces the PE extrudate 46 when the first and second plies 30, 40 are laminated together. The first ply 30 is applied to the molten PE extrudate 46 and compressed onto the second ply 40.

Upon cooling/curing of the PE extrudate 46, the first ply 30 is bonded to the second ply 40 to form the laminate material 10. The bond strength between the plies 30, 40 is limited by the release primer 39, which has been selectively applied between the paper layer 32 and the PE extrudate 46.

In use, when vacuum is applied to the food contained within the package, the second ply 40 will generally conform to the outer surface of the food within the package. The vacuum causes the first and second plies 30, 40 to delaminate in places where the release primer 39 is present. A thin cushion of air is permitted to form between the first ply 30 and the second ply 40. Thus, the first ply 30 is not subject to the vacuum force and it maintains a generally flat surface, in the area(s) where the release primer 39 has been applied.

An alternative construction for the laminate material 51 is shown in FIG. 4 and includes the adhesive lamination of the first ply 50 to the second ply 60. The release primer 59 may be applied with a pattern engraved primer cylinder coating station. The primer pattern corresponds to the impression size of the final package. The release primer 59 may be tinted to facilitate the registration and/or re-registration of the pattern to the roll. In the case of tinting, an optical scanner may be used to detect the application location of the primer 59. If the primer location varies from the desired location, the speed of one of the roll or the cylinder may be adjusted. Those skilled in the art will recognize that other methods of detecting the location of the release primer 59 may be used without departing from the scope of the present invention. Similar registration methods may be used for the application of ink 53 to the paper 52. The ink layer 53 may further be covered with an OPV layer 54.

In this second embodiment of the laminate 51, the second ply 60 is preferably similar to the second ply 40 of the first mentioned laminate 10. The second ply 60 is constructed by first unrolling a the sealant layer 62, applying laminating adhesive 63 thereto and laminating the barrier layer 64 to the sealant layer 62 by passing the layers 62, 63, 64 (barrier and sealant) through a laminator nip roller assembly. After passing through the nip roller, the tie layer 65 and the PE extrudate 66 are applied to the second ply 60.

The present invention may also be constructed by surface printing the paper 52 and either replacing the PE print web layer with another suitable layer or eliminating the PE print web layer all together. The PE print web may be replaced with a layer of overprint varnish (OPV) or some other suitable surface coating.

The release primer 59 is preferably pattern applied to facilitate delamination of the first ply 50 from the second ply 60 in the center 24, while allowing the edges 12, 16, 20, 22 of each piece to remain adhered together. This may be accomplished by only applying the release primer 59 to the central portions 24 of the laminated material. Alternatively, it may be desirable to have the top and bottom sections 12, 16 of each piece 4 of laminate material 10 delaminate with the central portion 24.

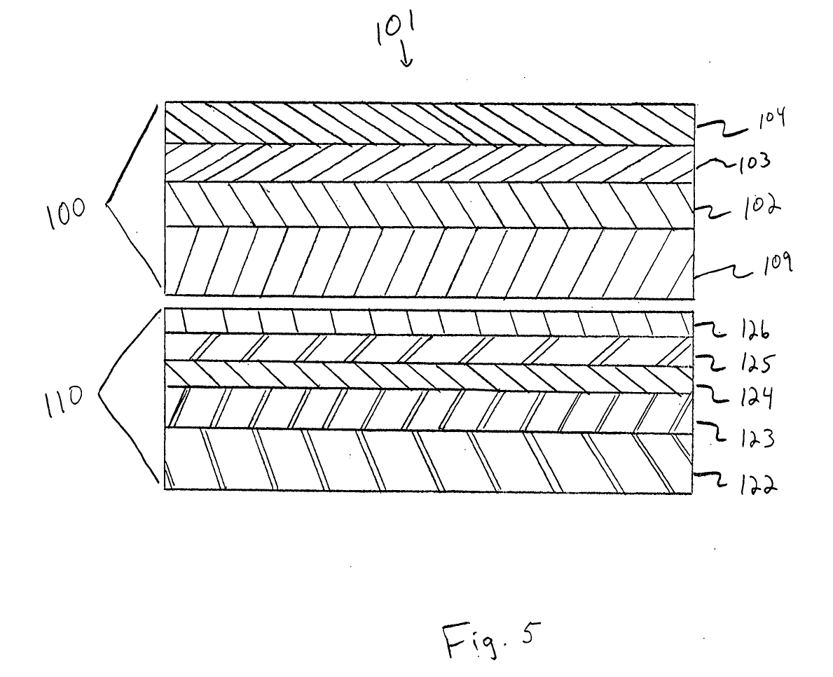

In a further alternative construction, shown in FIG. 5, a third embodiment of the laminate material 101 has a first ply 100 and a second ply 120. The first ply 100 comprises a paper layer 102 having one side printed with ink 103 and covered with a PE web layer 104. The other side of the paper layer 102 preferably has a weak adhesive layer 109 applied to a central portion thereof. The perimeter of the paper layer 102 preferably has a strong adhesive layer (not shown) applied thereto around the weak adhesive layer 109. The weak adhesive layer 109 may be a thinner application (i.e. less volume of adhesive per unit of area) of the same adhesive used in the strong adhesive layer or may be an adhesive having a lower tactile strength than the strong adhesive layer. The tactile strength differential between the weak adhesive layer 109 and the strong adhesive layer is preferably such that, upon application of vacuum to the food contained within the package, the weak adhesive layer 109 will fail and allow the first ply 110 to delaminate from the second ply 120 while the perimeter of the plies 100, 120 covered by the strong adhesive layer remain adhered together.

In the third embodiment of the laminate 101, the second ply 120 is preferably similar to the second ply 40 of the first mentioned laminate 10. The second ply 120 is constructed by first unrolling a the sealant layer 122, applying laminating adhesive 123 thereto and laminating the barrier layer 124 to the sealant layer 122 by passing the layers 122, 123, 124 (barrier and sealant) through a laminator nip roller assembly. After passing through the nip roller, the tie layer 125 and the PE extrudate 126 are applied to the second ply 120. In the laminate 101, the PE extrudate may be cooled prior to mating to the first layer 100 because the first and second layers 100, 120 are bonded together by the weak adhesive layer 109. Alternatively, the paper 102 may be adhered directly to the barrier layer 124 without the use of the tie layer 125 and the PE extrudate layer.

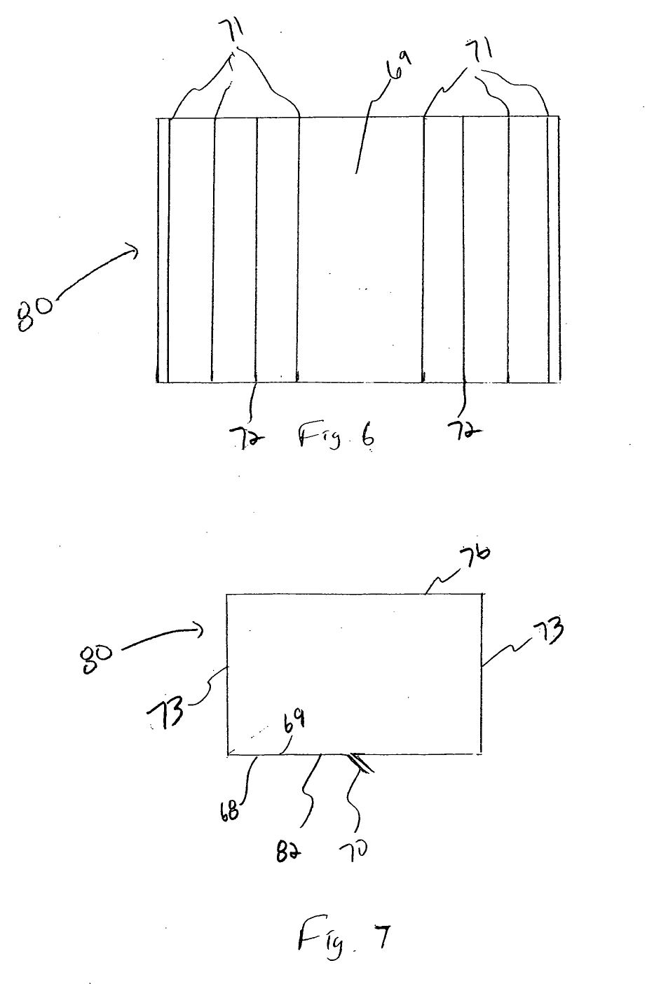

As illustrated in FIGS. 6-8, the laminate material 10 (or 51, 101) forms a package 80 for containing food. As illustrated, the package is formed by first folding the laminate material along longitudinal fold lines 71. The folded material preferably forms a package 80 having a generally rectangular cross-section, as seen in FIG. 7, with side panels 73, a top panel 76, a bottom panel 82 and a seam tab 70. The seam tab 70 is formed when the longitudinal sides 20, 22 are sealed together. Those skilled in the art will recognize that the package may have any other cross sectional profile, without departing from the scope of the present invention. Additional fold lines 72 may be used to flatten the package 80 for ease of shipping, prior to filling the package with food. Preferably, the additional folds 72 form gussets when the package is disposed in a flat condition.

Preferably, the first and second longitudinal side portions 20, 22 are heat sealed together. The inner faces of each of the end portions are folded to face each other. Heat is then preferably applied to fuse the sealant layer 42 of the first side portion 20 to the sealant layer 42 of the second side portion 22.

After the longitudinal side portions are sealed, the abutting faces 69 of the bottom portion of the inside face are heat sealed together to seal the bottom end of the package. This step may also be performed prior to or simultaneously with the sealing of the longitudinal side portions 20, 22.

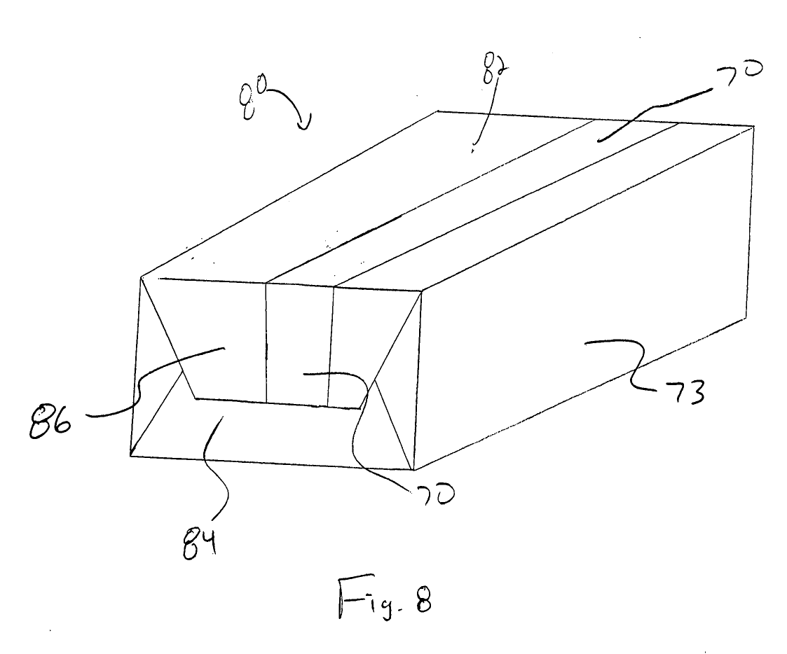

The package 80 is preferably filled with content and vacuumized according to known methods. At the time of vacuumization, the food or other content may take the shape of a brick or other desired shape. This may be done by placing the food in a mold prior to filling. Upon filling and vacuumization, the top edge portions 12 of the package are then sealed (see FIG. 8) using similar methods as those used to seal the side 20, 22 and bottom edge portions 16. After sealing each of the edge portions, the resulting tab 86 is folded over to lay flat on the surface of the package.

Upon vacuumization, there is a selective delamination of the first ply 30 and the second ply 40. The second ply 40 preferably conforms to the outer surface of the vacuumized contents, which may be bumpy or rough. The first ply 30, having separated from the second ply 40, maintains a generally smooth surface, which is suitable for displaying printed graphics or information.

FIG. 8 shows a brick package 80 constructed from the laminate material 10. The package 80 is shown up-side down, with a rear face 82 facing up. The seam tab 70 is folded flush against the package 80. A bottom end 84 of the brick package 80 is preferably folded closed, to create a substantially flat surface.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

1. A vacuum packed package comprising:
at least one flexible laminate panel having first and second plies;
a first bond formed between the first and second plies around an exterior edge portion of the panel and a relatively weaker second bond between the first and second plies in a central portion of the panel;
the laminate folded and sealed to define an interior package cavity for receiving the package content, and
at least a portion of the first ply adapted to separate from the second ply due to the relatively weak second bond in the central region of the laminate upon the introduction of vacuum to an interior cavity of the package.

2. The package according to claim 1, wherein the second bond is defined in part by a release layer disposed between the first and second plies.

3. The package according to claim 1, wherein the first ply is an inner layer comprising laminated materials that substantially restrict the flow of oxygen.

4. The package according to claim 1, wherein the second ply is an outer layer comprising laminated materials that are printable.

5. The package according to claim 1, wherein the first bond is formed with an adhesive layer and the second bond is formed with an adhesive layer that is weaker than the adhesive layer of the first bond.

6. The package according to claim 5, wherein the adhesive layer of the second bond is thinner than the adhesive layer of the first bond.

7. The package according to claim 5, wherein the adhesive of the second bond has a lower tactile strength than the adhesive of the first bond.

8. A method of vacuum packaging food comprising:
providing a panel constructed from a laminate material having at least an outer first ply and an inner second ply, the first and second plies bonded around a perimeter thereof and bonded by a relatively weaker bond in a central portion of the panel, joining a first edge portion of the panel to an opposing second edge portion of the panel, forming a cavity and inserting a food product therein, and
applying vacuum to the cavity and sealing the package, the applied vacuum delaminating the two plies due to the failure of the weaker bond.

9. The method according to claim 8, further comprising applying a release primer to the center portion of the panel between the first and second plies.

10. The method according to claim 8, further comprising printing on at least one surface of the outer first layer.

11. The method according to claim 8, further comprising forming the food into the shape of a brick prior to application of the vacuum.

12. A flexible laminate panel for forming a vacuum packed package, the panel comprising:
first and second plies bonded together by a first adhesive within a first pattern and a second, relatively weaker adhesive, applied on one of the plies in a second pattern,
wherein the second adhesive is comprised of a material that prevents the formulation of a destruct-type bond between the first and second plies.

13. The panel of claim 12 wherein the second adhesive is disposed proximate a center portion of either the first or second plies.

14. The panel of claim 12 wherein the second adhesive is applied in conjunction with a release layer.

15. The panel of claim 14 wherein the release layer is comprised of a material that is permeable to gasses.

16. The panel of claim 14 wherein the release layer is selected from the group consisting of a catalytically cured silicone release coating and a polyamide over print varnish.
